(19) United States
(12) Patent Application Publication
(10) Pub. No.: US 2021/0293258 A1
(43) Pub. Date: Sep. 23, 2021

(54) PRESSURE BOOSTER

(71) Applicant: SMC CORPORATION, Chiyoda-ku (JP)

(72) Inventors: Hiroyuki ASAHARA, Tsukuba-shi (JP); Kengo MONDEN, Ushiku-shi (JP); Naoki SHINJO, Nagareyama-shi (JP); Seiichi NAGURA, Moriya-shi (JP); Kazutaka SOMEYA, Kashiwa-shi (JP)

(73) Assignee: SMC CORPORATION, Chiyoda-ku (JP)

(21) Appl. No.: 16/462,623

(22) PCT Filed: Aug. 17, 2017
(86) PCT No.: PCT/JP2017/029505

§ 371 Date: May 21, 2019

(30) Foreign Application Priority Data
Nov. 22, 2016 (JP) 2016-226430

(51) Int. Cl. F15B 3/00

(52) U.S. Cl. CPC F15B 3/00; F15B 2211/6336; F15B 2211/77; F15B 2211/7055; F15B 2211/665

(57) ABSTRACT

A first position detection sensor and a second position detection sensor of a pressure booster detect the position of a first piston or a second piston. A fluid supply mechanism supplies a fluid to a first pressure-boosting chamber and/or a second pressure-boosting chamber. On the basis of the detection results of the first position detection sensor and the second position detection sensor, the fluid supply mechanism switches between performing an operation for supplying fluid to a first drive chamber and discharging fluid from a second drive chamber, and performing an operation for discharging fluid from the first drive chamber and supplying fluid to the second drive chamber.

### TECHNICAL FIELD

The present invention relates to a pressure booster adapted to increase the pressure of a fluid.

### BACKGROUND ART

With the object of supplying a high pressure fluid to a fluid pressure apparatus, a pressure booster, which increases the pressure of a supplied fluid, and outputs the fluid after having been boosted in pressure to the exterior, has been disclosed, for example, in Japanese Laid-Open Patent Publication No. 09-158901, Japanese Laid-Open Patent Publication No. 2008-223841, Japanese Laid-Open Patent Publication No. 2002-039105, Japanese Laid-Open Patent Publication No. 2001-311404, Japanese Laid-Open Patent Publication No. 10-267001, Japanese Laid-Open Patent Publication No. 10-267002, and Japanese Laid-Open Utility Model Publication No. 05-075501.

In such pressure boosters, a piston rod extends into a first chamber and a second chamber inside a cylinder, and by a first piston connected to one end of the piston rod inside the first chamber, and a second piston connected to another end of the piston rod inside the second chamber, the interior of each of the first chamber and the second chamber are partitioned into a pressure boosting chamber and a drive chamber. In addition, the first piston and the second piston are made to move reciprocally by supplying and discharging the fluid with respect to the drive chamber, thereby increasing the pressure of the fluid inside the pressure boosting chamber, and outputting the fluid after having been boosted in pressure to the exterior.

### SUMMARY OF INVENTION

However, in a conventional pressure booster, in order to prevent the pistons from being stopped midway during the pressure boosting operation, a drive mechanism (stop prevention mechanism) having a multilayer structure by a mechanical mechanism is provided, and thus, the internal structure is complex. Further, since a regulator is installed thereon for adjusting a pressure value of the fluid as an object to be boosted in pressure, the exterior dimensions are large.

Further, in the conventional pressure booster, operations of supplying and discharging the fluid are switched, as a result of knock pins being incorporated in the device, and the pistons being caused to abut against the knock pins. However, there is a problem in that sounds (hammering noises) which occur each time that the pistons move and abut against the knock pins produce noise, and the sounds (operating sounds) generated by the pressure booster during operation of the pistons is large.

The present invention has been devised in order to solve the aforementioned problems, and has the object of providing a pressure booster which is capable of simplifying the internal structure together with reducing the exterior dimensions of the pressure booster.

A further object of the present invention is to provide a pressure booster in which operating sounds are capable of being reduced.

The pressure booster according to the present invention includes a first chamber and a second chamber adjacent to the first chamber. In this case, a piston rod extends to the first chamber and the second chamber. Inside the first chamber, by connecting a first piston to one end of the piston rod, the first chamber is partitioned into a first pressure boosting chamber on the side of the second chamber, and a first drive chamber remote from the second chamber. On the other hand, inside the second chamber, by connecting a second piston to another end of the piston rod, the second chamber is partitioned into a second pressure boosting chamber on the side of the first chamber, and a second drive chamber remote from the first chamber.

In addition, in the pressure booster, a position detecting sensor detects the position of the first piston or the second piston. Further, in the pressure booster, by a fluid supplying mechanism, fluid is supplied to at least one of the first pressure boosting chamber and the second pressure boosting chamber, together with there being executed, based on a detection result of the position detecting sensor, switching between an operation of supplying the fluid to the first drive chamber and discharging the fluid from the second drive chamber, and an operation of discharging the fluid from the first drive chamber and supplying the fluid to the second drive chamber.

In this manner, according to the present invention, instead of a conventional mechanism for driving the pistons by a mechanical mechanism, the first piston, the piston rod, and the second piston are driven by electrically controlling the movement direction on the basis of the detection result of the position detecting sensor. Consequently, the drive mechanism of the first piston, the piston rod, and the second piston can be simplified, and the internal structure of the pressure booster can be made in a simple and straightforward manner.

Further, in the pressure booster, a control is performed only to supply the fluid to at least one from among the first pressure boosting chamber and the second pressure boosting chamber and to supply or discharge the fluid with respect to the first drive chamber and the second drive chamber. Accordingly, in the present invention, there is no need for a regulator, and a pressure value (set value) of the fluid after having been boosted in pressure is fixed. As a result, the external dimensions of the pressure booster can be reduced, and the pressure booster can be made compact.

Furthermore, in the present invention, as described above, since the operations of supplying and discharging the fluid are switched on the basis of the detection result of the position detecting sensor, the aforementioned knock pins are rendered unnecessary. As a result, noises generated upon movement of the first and second pistons can be suppressed, and operating sounds of the pressure booster can be reduced.

In this instance, the fluid supplying mechanism is equipped with a first supply flow passage configured to supply the fluid supplied from the exterior into the first pressure boosting chamber, a second supply flow passage configured to supply the fluid supplied from the exterior into the second pressure boosting chamber, a first solenoid valve configured to supply the fluid supplied from the exterior into the first drive chamber, or to discharge the fluid inside the first drive chamber to the exterior, on the basis of the detection result of the position detecting sensor, and a second solenoid valve configured to supply the fluid supplied from the exterior into the second drive chamber, or to discharge the fluid inside the second drive chamber to the exterior, on the basis of the detection result of the position detecting sensor.

In this manner, by using the first solenoid valve and the second solenoid valve, switching of the direction of movement of the first piston, the piston rod, and the second piston is carried out electrically, and thus the internal structure of the pressure booster can be further simplified.

In this case, the fluid supplying mechanism may further include a first inlet check valve provided in the first supply flow passage and configured to prevent back-flowing of the fluid from the first pressure boosting chamber, and a second inlet check valve provided in the second supply flow passage and configured to prevent back-flowing of the fluid from the second pressure boosting chamber. In accordance with this feature, in the first pressure boosting chamber and the second pressure boosting chamber, the pressure of the fluid can be reliably increased.

Further, the pressure booster further includes a fluid output mechanism configured to output to the exterior the fluid which was boosted in pressure in the first pressure boosting chamber or the second pressure boosting chamber. In this case, the fluid output mechanism may be configured to include a first outlet check valve configured to prevent back-flowing of the fluid into the first pressure boosting chamber, and a second outlet check valve configured to prevent back-flowing of the fluid into the second pressure boosting chamber. In accordance with this feature, in the first pressure boosting chamber and the second pressure boosting chamber, the pressure of the fluid can more reliably be increased.

Further, the position detecting sensor may include a first position detecting sensor configured to detect arrival of the first piston or the second piston at one end side of the first chamber or the second chamber, and a second position detecting sensor configured to detect arrival of the first piston or the second piston at another end side of the first chamber or the second chamber. In accordance with this feature, since it is easy to detect the position of the first piston or the second piston, the internal structure of the pressure booster can be further simplified, and it becomes possible to enhance the productivity of the pressure booster.

Furthermore, the position detecting sensor may include a magnetic sensor configured to detect the position of the first piston or the second piston by detecting magnetism produced by a magnet attached to the first piston or the second piston. Consequently, the position of the first piston or the second piston can be detected easily and accurately.

Further, in the pressure booster, a center body is interposed between the first chamber and the second chamber, a first cover member is disposed at an end of the first drive chamber remote from the center body, and a second cover member is disposed at an end of the second drive chamber remote from the center body. In this case, the first piston may be displaced inside the first chamber without coming into contact with the center body and the first cover member, and the second piston may be displaced inside the second chamber without coming into contact with the center body and the second cover member.

In accordance with this feature, the first piston and the second piston are capable of being moved smoothly when the fluid is supplied to or discharged from the first pressure boosting chamber, the second pressure boosting chamber, the first drive chamber, and the second drive chamber.

The above and other objects, features, and advantages of the present invention will become more apparent from the following description of a preferred exemplary embodiment when taken in conjunction with the accompanying drawings.

### BRIEF DESCRIPTION OF DRAWINGS

FIG. 1 is a perspective view of a pressure booster according to a present embodiment;

FIG. 2 is a perspective view of the pressure booster of FIG. 1 as viewed from a different direction;

FIG. 3 is an exploded perspective view illustrating a control unit in a state of being separated away from a center body shown in FIG. 2;

FIG. 4 is a cross-sectional view taken along line IV-IV of FIG. 1;

FIG. 5 is a perspective view in which an upper side portion of the pressure booster shown in FIG. 1 is illustrated in cutaway;

FIG. 6 is a configuration diagram of a first solenoid valve and a second solenoid valve;

FIG. 7 is a schematic cross-sectional view showing principles of operation of the pressure booster of FIG. 1; and

FIG. 8 is a schematic cross-sectional view showing principles of operation of the pressure booster of FIG. 1.

### DESCRIPTION OF EMBODIMENTS

A preferred embodiment of a pressure booster according to the present invention will be described in detail below with reference to the drawings.

### Configuration of Present Embodiment

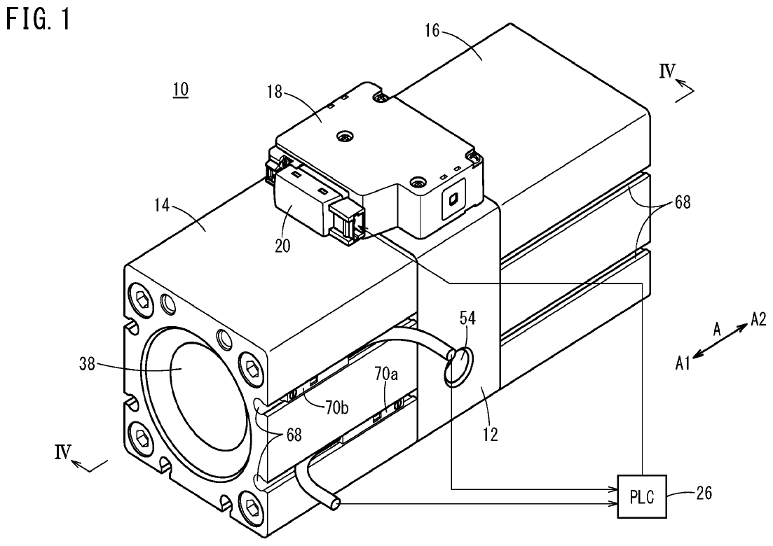

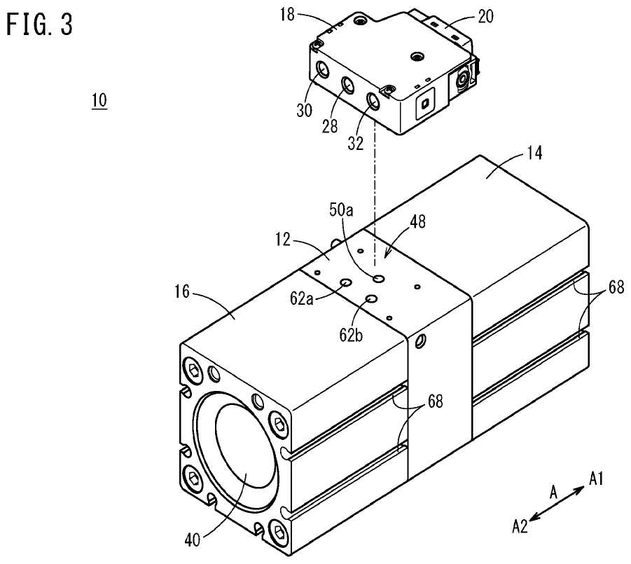

As shown in FIGS. 1 to 5, a pressure booster 10 according to the present embodiment includes a tandem type cylinder structure in which a first cylinder 14 is disposed contiguously on one end side (a side in the A1 direction) of a center body 12, and a second cylinder 16 is disposed contiguously on another end side (a side in the A2 direction) of the center body 12. Accordingly, in the pressure booster 10, the first cylinder 14, the center body 12, and the second cylinder 16 are disposed contiguously in this order from the A1 direction toward the A2 direction. Moreover, the outer peripheral surfaces of the first cylinder 14, the center body 12, and the second cylinder 16 are formed substantially flush with each other.

A block-shaped control unit 18 is disposed on an upper surface of the center body 12. In the control unit 18, a connector 20 is disposed on a side surface in the A1 direction. The connector 20 is connected to a first solenoid valve 22 and a second solenoid valve 24 in the control unit 18, and on the other hand, is capable of being connected to a PLC (Programmable Logic Controller) 26, which is a higher order control device with respect to the pressure booster 10.

In the control unit 18, on a side surface thereof in the A2 direction, an inlet port 28 is provided that receives a supply of fluid (for example, air) from a non-illustrated external fluid supply source, and on both sides sandwiching the inlet port 28 therebetween, a first discharge port 30 and a second discharge port 32 are provided.

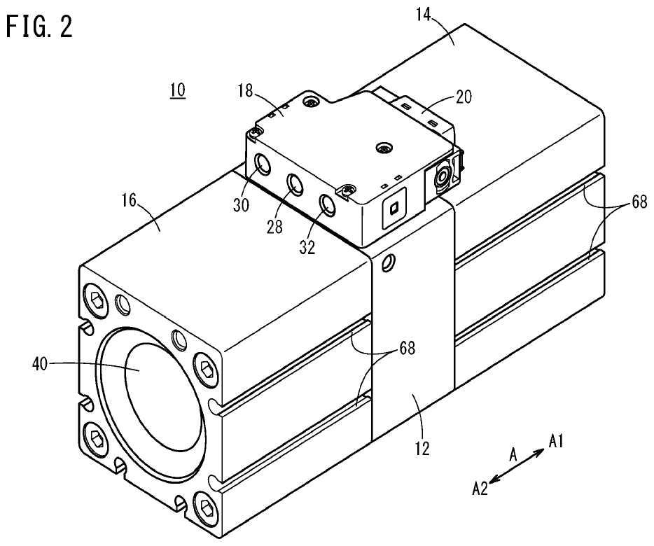

As shown in FIGS. 2 to 4, a first chamber 34 is formed inside the first cylinder 14, whereas a second chamber 36 is formed inside the second cylinder 16. In this case, a first cover member 38 is fixed to an end of the first cylinder 14 in the A1 direction, and the center body 12 is disposed at an end in the A2 direction, thereby forming the first chamber 34. On the other hand, the center body 12 is disposed at an end in the A1 direction of the second cylinder 16, and a second cover member 40 is fixed to an end in the A2 direction, thereby forming the second chamber 36.

Additionally, in the interior of the pressure booster 10, a piston rod 42 penetrates through the center body 12 in the A directions, and extends to the first chamber 34 and the second chamber 36. In the first chamber 34, a first piston 44 is connected to one end of the piston rod 42 in the A1 direction. Consequently, the first chamber 34 is partitioned into a first pressure boosting chamber 34a on a side in the A2 direction, and a first drive chamber 34b on a side in the A1 direction. On the other hand, in the second chamber 36, a second piston 46 is connected to another end of the piston rod 42 in the A2 direction. Consequently, the second chamber 36 is partitioned into a second pressure boosting chamber 36a on a side in the A1 direction, and a second drive chamber 36b on a side in the A2 direction. Moreover, the first piston 44 is displaced inside the first chamber 34 in the A directions without coming into contact with the center body 12 and the first cover member 38. Further, the second piston 46 is displaced inside the second chamber 36 in the A directions without coming into contact with the center body 12 and the second cover member 40.

In the aforementioned control unit 18 and the center body 12, a fluid supplying mechanism 48 is provided, which communicates with the inlet port 28, and supplies the fluid that is supplied from the fluid supply source through the inlet port 28 to at least one from among the first pressure boosting chamber 34a and the second pressure boosting chamber 36a.

The fluid supplying mechanism 48 includes an inlet flow passage 50a that communicates with the inlet port 28 and extends downwardly from the upper surface of the center body 12, a first supply flow passage 50b through which the inlet flow passage 50a and the first pressure boosting chamber 34a communicate with each other, and a second supply flow passage 50c through which the inlet flow passage 50a and the second pressure boosting chamber 36a communicate with each other.

A first inlet check valve 52a, which permits the supply of fluid from the inlet port 28 to the first pressure boosting chamber 34a, while preventing back-flowing of the fluid from the first pressure boosting chamber 34a, is provided in the first supply flow passage 50b. Further, a second inlet check valve 52b, which permits the supply of fluid from the inlet port 28 to the second pressure boosting chamber 36a, while preventing back-flowing of the fluid from the second pressure boosting chamber 36a, is provided in the second supply flow passage 50c.

An output port 54, which outputs to the exterior the fluid that has been boosted in pressure in accordance with a later-described pressure boosting operation by the pressure booster 10, is formed on the front surface of the center body 12. Further, a fluid output mechanism 56, which communicates with the output port 54, and outputs to the exterior via the output port 54 the fluid that has been boosted in pressure in the first pressure boosting chamber 34a or the second pressure boosting chamber 36a, is provided in the center body 12.

The fluid output mechanism 56 is provided on a lower side portion of the piston rod 42 in the center body 12. The fluid output mechanism 56 includes a first output flow passage 58a through which the output port 54 and the first pressure boosting chamber 34a communicate with each other, and a second output flow passage 58b through which the output port 54 and the second pressure boosting chamber 36a communicate with each other.

A first outlet check valve 60a, which permits output of the fluid after having been boosted in pressure, from the first pressure boosting chamber 34a to the output port 54, while preventing back-flowing of the fluid into the first pressure boosting chamber 34a, is provided in the first output flow passage 58a. Further, a second outlet check valve 60b, which permits output of the fluid after having been boosted in pressure, from the second pressure boosting chamber 36a to the output port 54, while preventing back-flowing of the fluid into the second pressure boosting chamber 36a, is provided in the second output flow passage 58b.

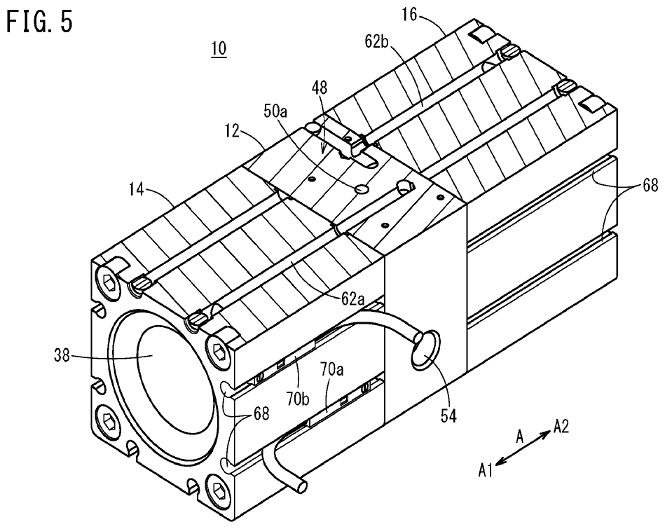

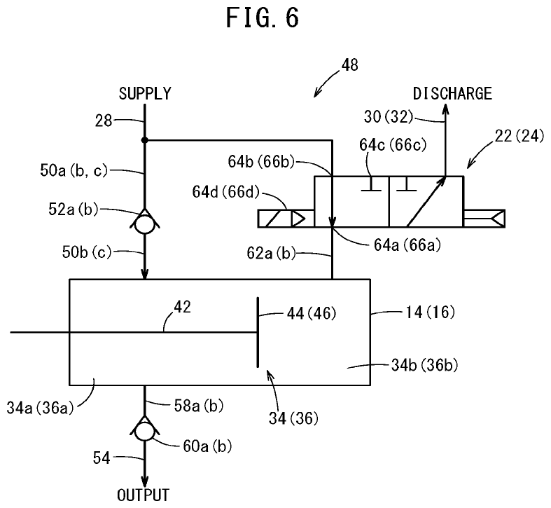

As shown in FIGS. 5 and 6, the fluid supplying mechanism 48 further includes a first drive flow passage 62a communicating with the first drive chamber 34b, and a second drive flow passage 62b communicating with the second drive chamber 36b. The first drive flow passage 62a is a flow passage that interconnects the first drive chamber 34b and a connection port 64a of the first solenoid valve 22, and extends in the A directions in upper side portions inside the first cylinder 14 and the center body 12. One end of the first drive flow passage 62a communicates with the first drive chamber 34b, and the other end thereof communicates with the connection port 64a of the first solenoid valve 22 inside the control unit 18. On the other hand, the second drive flow passage 62b is a flow passage that interconnects the second drive chamber 36b and a connection port 66a of the second solenoid valve 24, and extends in the A directions in upper side portions inside the second cylinder 16 and the center body 12. One end of the second drive flow passage 62b communicates with the second drive chamber 36b, and the other end thereof communicates with the connection port 66a of the second solenoid valve 24 inside the control unit 18.

Each of the first solenoid valve 22 and the second solenoid valve 24 is a single-acting two-position three-port solenoid valve. More specifically, the first solenoid valve 22 includes the connection port 64a, which is connected to the first drive chamber 34b via the first drive flow passage 62a, a supply port 64b, a discharge port 64c, and a solenoid 64d. On the other hand, the second solenoid valve 24 includes the connection port 66a, which is connected to the second drive chamber 36b via the second drive flow passage 62b, a supply port 66b, a discharge port 66c, and a solenoid 66d.

In this instance, in the case that control signals are supplied from the PLC 26 to the solenoid 64d through the connector 20, while on the other hand, control signals are not supplied with respect to the solenoid 66d (supply of the control signals is halted), the supply port 64b of the first solenoid valve 22 and the connection port 64a are connected, together with the discharge port 66c of the second solenoid valve 24 and the connection port 66a being connected. Consequently, fluid is supplied from the inlet port 28 to the first drive chamber 34b via the first drive flow passage 62a, whereas the fluid inside the second drive chamber 36b is discharged to the exterior through the second drive flow passage 62b and the second discharge port 32. As a result, the first piston 44, the piston rod 42, and the second piston 46 are displaced toward the second drive chamber 36b (in the direction A2) by the pressure of the fluid supplied to the first drive chamber 34b.

On the other hand, in the case that supply of control signals from the PLC 26 to the solenoid 64d is stopped, while on the other hand, control signals are supplied to the solenoid 66d through the connector 20, the discharge port 64c of the first solenoid valve 22 and the connection port 64a are connected, together with the supply port 66b of the second solenoid valve 24 and the connection port 66a being connected. Consequently, the fluid inside the first drive chamber 34b is discharged to the exterior through the first drive flow passage 62a and the first discharge port 30, whereas the fluid is supplied to the second drive chamber 36b from the inlet port 28 via the second drive flow passage 62b. As a result, the first piston 44, the piston rod 42, and the second piston 46 are displaced toward the first drive chamber 34b (in the direction A1) by the pressure of the fluid supplied to the second drive chamber 36b.

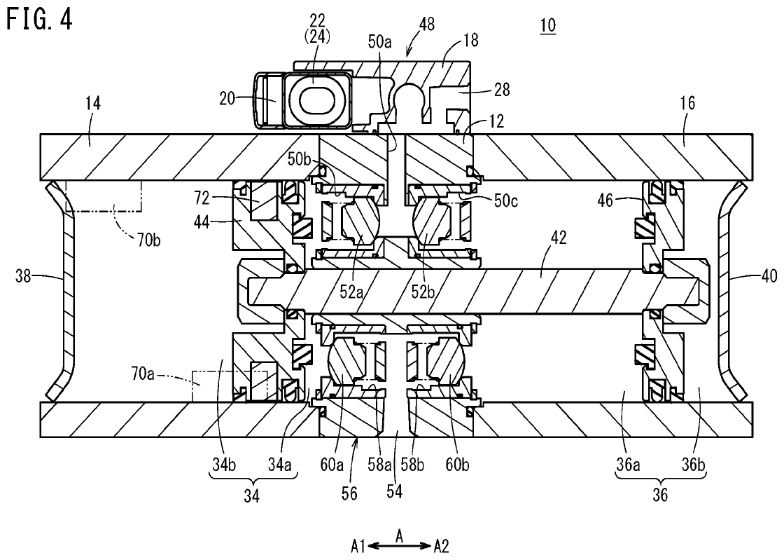

As shown in FIGS. 1 to 3 and 5, two grooves 68 that extend in the A directions are formed above and below on each of side surfaces (a front surface on the side of the output port 54, and a rear surface) of each of the first cylinder 14 and the second cylinder 16. A first position detecting sensor 70a and a second position detecting sensor 70b are embedded respectively in the two grooves 68 formed on the front surface of the first cylinder 14. Further, as shown in FIG. 4, an annular permanent magnet 72 is embedded in an outer circumferential surface of the first piston 44.

The first position detecting sensor 70a is a magnetic sensor, which detects the magnetism of the permanent magnet 72 when the first piston 44 is displaced to a location (one end side of the first chamber 34) in the vicinity of the center body 12 inside the first chamber 34, and outputs a detection signal thereof to the PLC 26. The second position detecting sensor 70b is a magnetic sensor, which detects the magnetism of the permanent magnet 72 when the first piston 44 is displaced to a location (another end side of the first chamber 34) in the vicinity of the first cover member 38 inside the first chamber 34, and outputs a detection signal thereof to the PLC 26. More specifically, the first position detecting sensor 70a and the second position detecting sensor 70b detect the position of the first piston 44 by detecting the magnetism produced by the permanent magnet 72. On the basis of the detection signals from the first position detecting sensor 70a and the second position detecting sensor 70b, the PLC 26 outputs to the connector 20 control signals in order to excite the solenoid 64d or the solenoid 66d.

### Operations of the Present Embodiment

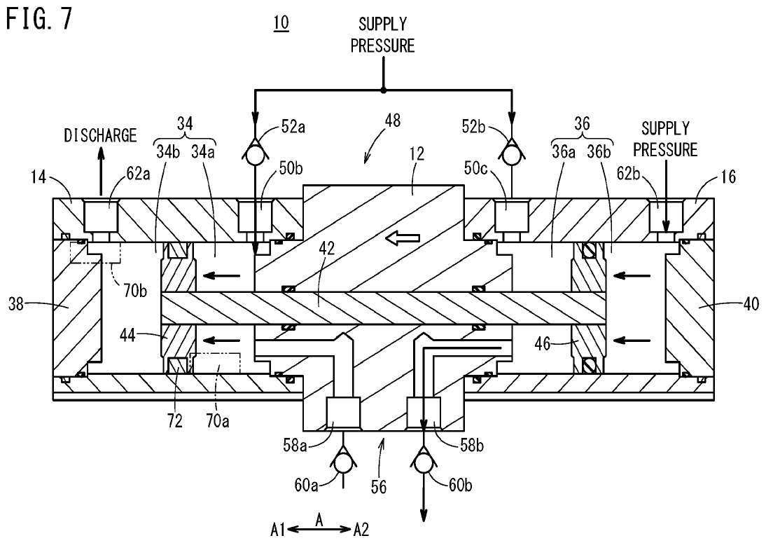

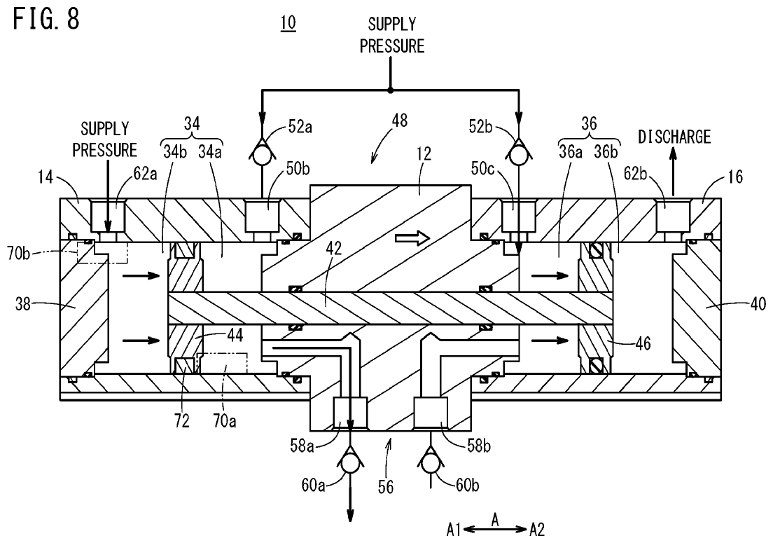

Operations of the pressure booster 10, which is configured in the manner described above, will be described with reference to FIGS. 7 and 8. In providing such operational descriptions, reference will also be made to FIGS. 1 through 6 as necessary. Moreover, in order to facilitate the description, in FIGS. 7 and 8, it should be noted that the cross-sectional shape of the pressure booster 10 is illustrated schematically and in a deformed manner.

In this instance, a description will be given of a case in which, by causing the first piston 44 and the second piston 46 to be displaced alternately in the A1 direction and the A2 direction, the fluid (for example, air) which is supplied to the first pressure boosting chamber 34a and the second pressure boosting chamber 36a is alternately boosted in pressure and output to the exterior.

At first, with reference to FIG. 7, a case will be described in which the fluid supplied to the second pressure boosting chamber 36a is boosted in pressure by causing the first piston 44 and the second piston 46 to be displaced in the A1 direction.

In this case, for example, the first piston 44 is positioned inside the first chamber 34 and is separated by a slight gap from the center body 12, and the second piston 46 is positioned inside the second chamber 36 and is separated by a slight gap from the second cover member 40.

The fluid supplied from the external fluid supply source is supplied from the inlet port 28 to the fluid supplying mechanism 48. The fluid supplying mechanism 48 supplies the fluid to the first pressure boosting chamber 34a via the first supply flow passage 50b. It should be noted that, in the second pressure boosting chamber 36a, fluid is already filled therein by a previous operation.

In this instance, the first position detecting sensor 70a detects the magnetism produced by the permanent magnet 72 that is mounted on the first piston 44, and outputs a detection signal thereof to the PLC 26. On the basis of the detection signal from the first position detecting sensor 70a, the PLC 26 outputs a control signal to the connector 20 in order to excite the solenoid 66d of the second solenoid valve 24. Consequently, the control signal is input to the control unit 18 via the connector 20.

The solenoid 66d of the second solenoid valve 24 is excited due to the supply of the control signal (first position), and the second drive chamber 36b communicates with the inlet port 28 via the second drive flow passage 62b, the connection port 66a, and the supply port 66b. Consequently, the fluid from the fluid supply source is supplied to the second drive chamber 36b via the second drive flow passage 62b, etc. Due to the fluid supplied to the second drive chamber 36b, a pressing force directed toward the first drive chamber 34b (in the direction A1) acts on the second piston 46.

On the other hand, since a control signal is not supplied with respect to the solenoid 64d of the first solenoid valve 22, the solenoid 64d is placed in a demagnetized state (second position). Consequently, the first drive chamber 34b is connected to the first discharge port 30 via the first drive flow passage 62a, the connection port 64a, and the discharge port 64c, and the fluid inside the first drive chamber 34b is discharged to the exterior. As a result, due to the fluid supplied to the first pressure boosting chamber 34a, the pressing force directed toward the first drive chamber 34b (in the direction A1) acts on the first piston 44.

In this manner, in the example of FIG. 7, fluid is supplied to the first pressure boosting chamber 34a, fluid is supplied to the second drive chamber 36b, and the fluid inside the first drive chamber 34b is discharged. Consequently, by the fluid supplied to the first pressure boosting chamber 34a and the second drive chamber 36b, the first piston 44 and the second piston 46 respectively receive pressing forces in the A1 direction. As a result, the first piston 44, the piston rod 42, and the second piston 46 are integrally displaced in the A1 direction as shown in FIG. 7.

Consequently, the fluid inside the second pressure boosting chamber 36a is compressed due to the displacement of the second piston 46 in the A1 direction, and the pressure value thereof is increased (boosted in pressure). In the second pressure boosting chamber 36a, it is possible to increase the pressure of the supplied fluid up to a pressure value that is two times that of the original pressure at a maximum. The fluid after having been boosted in pressure is output to the exterior through the second output flow passage 58b and the output port 54 of the fluid output mechanism 56.

In the case that the permanent magnet 72 is moved away from a detectable range of the first position detecting sensor 70a due to the movement of the first piston 44, the piston rod 42, and the second piston 46 in the A1 direction, the first position detecting sensor 70a stops outputting the detection signal with respect to the PLC 26. Thereafter, by the first piston 44 arriving at a position in the vicinity of the first cover member 38 (a position separated by a slight gap from the first cover member 38), movement of the first piston 44, the piston rod 42, and the second piston 46 in the A1 direction is stopped.

Next, with reference to FIG. 8, a case will be described in which the fluid supplied to the first pressure boosting chamber 34a is boosted in pressure by causing the first piston 44, the piston rod 42, and the second piston 46 to be displaced in the A2 direction.

Initially, the fluid supplying mechanism 48 supplies the fluid to the second pressure boosting chamber 36a via the second supply flow passage 50c. Moreover, by the previous operation shown in FIG. 7, fluid is already filled in the first pressure boosting chamber 34a. Further, the second position detecting sensor 70b detects the magnetism produced by the permanent magnet 72, and outputs a detection signal thereof to the PLC 26. On the basis of the detection signal from the second position detecting sensor 70b, with respect to the connector 20, the PLC 26 stops outputting the control signal with respect to the solenoid 66d of the second solenoid valve 24, while on the other hand, starts outputting a control signal with respect to the solenoid 64d of the first solenoid valve 22. Consequently, the control signal is input to the control unit 18 via the connector 20 in order to excite the solenoid 64d.

Therefore, the solenoid 64d of the first solenoid valve 22 is excited due to the supply of the control signal (first position), and the first drive chamber 34b communicates with the inlet port 28 via the first drive flow passage 62a, the connection port 64a, and the supply port 64b. Consequently, the fluid from the fluid supply source is supplied to the first drive chamber 34b via the first drive flow passage 62a, etc. Due to the fluid supplied to the first drive chamber 34b, a pressing force directed toward the second drive chamber 36b (in the direction A2) acts on the first piston 44.

On the other hand, since supply of the control signal is stopped with respect to the solenoid 66d of the second solenoid valve 24, the solenoid 66d is placed in a demagnetized state (second position). Consequently, the second drive chamber 36b is connected to the second discharge port 32 via the second drive flow passage 62b, the connection port 66a, and the discharge port 66c, and the fluid inside the second drive chamber 36b is discharged to the exterior. As a result, due to the fluid supplied to the second pressure boosting chamber 36a, the pressing force directed toward the second drive chamber 36b (in the direction A2) acts on the second piston 46.

Accordingly, in the example of FIG. 8, fluid is supplied to the second pressure boosting chamber 36a, fluid is supplied to the first drive chamber 34b, and the fluid inside the second drive chamber 36b is discharged. Consequently, by the fluid supplied to the first drive chamber 34b and the second pressure boosting chamber 36a, the first piston 44 and the second piston 46 respectively receive pressing forces in the A2 direction. As a result, the first piston 44, the piston rod 42, and the second piston 46 are integrally displaced in the A2 direction as shown in FIG. 8.

Consequently, the fluid inside the first pressure boosting chamber 34a is compressed due to the displacement of the first piston 44 in the A2 direction, and the pressure value thereof is increased (boosted in pressure). In the first pressure boosting chamber 34a as well, it is possible to increase the pressure of the supplied fluid up to a pressure value that is two times that of the original pressure at a maximum, and the fluid after having been boosted in pressure is output to the exterior through the first output flow passage 58a and the output port 54 of the fluid output mechanism 56.

In the case that the permanent magnet 72 is moved away from a detectable range of the second position detecting sensor 70b due to the movement of the first piston 44, the piston rod 42, and the second piston 46 in the A2 direction, the second position detecting sensor 70b stops outputting the detection signal to the PLC 26. Thereafter, by the second piston 46 arriving at a position in the vicinity of the second cover member 40 (a position separated by a slight gap from the second cover member 40), movement of the first piston 44, the piston rod 42, and the second piston 46 in the A2 direction is stopped.

In addition, with the pressure booster 10 according to the present embodiment, the pressure boosting operations shown in FIGS. 7 and 8 are carried out alternately by causing the first piston 44, the piston rod 42, and the second piston 46 to undergo reciprocal movement in the A1 direction and the A2 direction. Consequently, in the pressure booster 10, the pressure value of the fluid supplied from the external fluid supply source can be boosted in pressure up to a pressure value that is two times that of the original pressure at a maximum, and the fluid after having been boosted in pressure can be output to the exterior through the output port 54, alternately from the first pressure boosting chamber 34a and the second pressure boosting chamber 36a.

Moreover, the fluid after having been boosted in pressure which is output from the pressure booster 10 is stored in a non-illustrated external tank. As a result, it is possible for the fluid after having been boosted in pressure to be supplied to any arbitrary fluid pressure device.

### Advantages of the Present Embodiment

As has been described above, in accordance with the pressure booster 10 according to the present embodiment, instead of a conventional drive mechanism for driving the pistons by a mechanical mechanism, the first piston 44, the piston rod 42, and the second piston 46 are driven in the A1 direction and the A2 direction by electrically controlling the movement direction on the basis of the detection result of the first position detecting sensor 70a and the second position detecting sensor 70b. Consequently, the drive mechanism of the first piston 44, the piston rod 42, and the second piston 46 can be simplified, and the internal structure of the pressure booster 10 can be made in a simple and straightforward manner.

Further, in the pressure booster 10, a control is performed only to supply the fluid to at least one from among the first pressure boosting chamber 34a and the second pressure boosting chamber 36a, and to supply or discharge the fluid with respect to the first drive chamber 34b and the second drive chamber 36b. Accordingly, in the pressure booster 10, there is no need for a regulator, and a pressure value (set value) of the fluid after having been boosted in pressure is fixed. As a result, in comparison with a conventional pressure booster equipped with a regulator, the external dimensions of the pressure booster 10 can be reduced, and the pressure booster 10 can be made compact.

Further, conventionally, operations of supplying and discharging the fluid are switched, as a result of knock pins being incorporated in the pressure booster, and the pistons being caused to abut against the knock pins. However, there is a problem in that sounds (hammering noises) which occur each time that the pistons move and abut against the knock pins produce noise, and the sounds (operating sounds) generated by the pressure booster during operation of the pistons is large.

In contrast thereto, with the pressure booster 10 according to the present embodiment, as described above, since the operations of supplying and discharging the fluid are switched on the basis of the detection results of the first position detecting sensor 70a and the second position detecting sensor 70b, the aforementioned knock pins are rendered unnecessary. As a result, noises generated upon movement of the first piston 44 and the second piston 46 can be suppressed, and operating sounds of the pressure booster 10 can be reduced.

Further, by using the first solenoid valve 22 and the second solenoid valve 24, switching of the direction of movement of the first piston 44, the piston rod 42, and the second piston 46 is carried out electrically, and thus the internal structure of the pressure booster 10 can be further simplified.

Moreover, as has been described above, since the conventional pressure booster subjects the pistons to reciprocal motion by way of a mechanical mechanism, it is difficult to grasp from the exterior the number of times (how many times) that such reciprocal motion has been performed. In contrast thereto, with the pressure booster 10 according to the present embodiment, since the position of the first piston 44 can be easily detected by the first position detecting sensor 70a and the second position detecting sensor 70b, the number of times that the first piston 44, the piston rod 42, and the second piston 46 undergo reciprocating motion can be grasped by the PLC 26. Further, the pressure booster 10 can be suitably utilized, for example, in order to supply a pressure fluid to various fluid pressure devices in a production line of a factory. More specifically, this is because, in a factory, power supply lines are disposed at various locations, and the power supply for the first position detecting sensor 70a, the second position detecting sensor 70b, the first solenoid valve 22, and the second solenoid valve 24 can be easily secured.

Further, by the fluid supplying mechanism 48 being equipped with the first inlet check valve 52a and the second inlet check valve 52b, and by the fluid output mechanism 56 being equipped with the first outlet check valve 60a and the second outlet check valve 60b, in the first pressure boosting chamber 34a and the second pressure boosting chamber 36a, the pressure of the fluid can be reliably increased.

Further, by utilizing the first position detecting sensor 70a and the second position detecting sensor 70b, since it is easy to detect the position of the first piston 44, the internal structure of the pressure booster 10 can be further simplified, and it is possible to enhance the productivity of the pressure booster 10.

In addition, the first position detecting sensor 70a and the second position detecting sensor 70b are magnetic sensors that detect the position of the first piston 44 by detecting the magnetism produced by the permanent magnet 72 attached to the first piston 44, and therefore, it is possible to easily and accurately detect the position of the first piston 44.

In the above description, although a case has been described in which the first position detecting sensor 70a and the second position detecting sensor 70b detect the position of the first piston 44, it is a matter of course that the same effects can be obtained even in the case that the first position detecting sensor 70a and the second position detecting sensor 70b are embedded in the grooves 68 of the second cylinder 16, the permanent magnet 72 is attached to the second piston 46, and the position of the second piston 46 is detected by the first position detecting sensor 70a and the second position detecting sensor 70b.

Further, in the pressure booster 10, the center body 12 is interposed between the first chamber 34 and the second chamber 36, the first cover member 38 is disposed at an end of the first chamber 34 in the A1 direction remote from the center body 12, and the second cover member 40 is disposed at an end of the second chamber 36 in the A2 direction remote from the center body 12. In this case, the first piston 44 is displaced inside the first chamber 34 without coming into contact with the center body 12 and the first cover member 38, and the second piston 46 is displaced inside the second chamber 36 without coming into contact with the center body 12 and the second cover member 40. In accordance with this feature, the first piston 44 and the second piston 46 are capable of being moved smoothly when the fluid is supplied to or discharged from the first pressure boosting chamber 34a, the second pressure boosting chamber 36a, the first drive chamber 34b, and the second drive chamber 36b.

The present invention is not limited to the embodiments described above, and it is a matter of course that various modified or additional structures could be adopted therein without deviating from the essence and gist of the present invention as set forth in the appended claims.

1. A pressure booster, comprising:
a first chamber;
a second chamber adjacent to the first chamber;
a piston rod extending to the first chamber and the second chamber;
a first piston which, by being connected to one end of the piston rod inside the first chamber, is configured to partition the first chamber into a first pressure boosting chamber on a side of the second chamber, and a first drive chamber remote from the second chamber;
a second piston which, by being connected to another end of the piston rod inside the second chamber, is configured to partition the second chamber into a second pressure boosting chamber on a side of the first chamber, and a second drive chamber remote from the first chamber;
a position detecting sensor configured to detect a position of the first piston or the second piston; and
a fluid supplying mechanism configured to supply fluid to at least one of the first pressure boosting chamber and the second pressure boosting chamber, together with executing, based on a detection result of the position detecting sensor, switching between an operation of supplying the fluid to the first drive chamber and discharging the fluid from the second drive chamber, and an operation of discharging the fluid from the first drive chamber and supplying the fluid to the second drive chamber.

2. The pressure booster according to claim 1, wherein the fluid supplying, mechanism comprises:
a first supply flow passage configured to supply the fluid supplied from exterior into the first pressure boosting chamber;
a second supply flow passage configured to supply the fluid supplied from the exterior into the second pressure boosting chamber;
a first solenoid valve configured to supply the fluid supplied from the exterior into the first drive chamber, or to discharge the fluid inside the first drive chamber to the exterior, based on a detection result of the position detecting sensor; and
a second solenoid valve configured to supply the fluid supplied from the exterior into the second drive chamber, or to discharge the fluid inside the second drive chamber to the exterior, based on the detection result of the position detecting sensor.

3. The pressure booster according to claim 2, wherein the fluid supplying mechanism further comprises:
a first inlet check valve provided in the first supply flow passage and configured to prevent back-flowing of the fluid from the first pressure boosting chamber; and
a second inlet check valve provided in the second supply flow passage and configured to prevent back-flowing of the fluid from the second pressure boosting chamber.

4. The pressure booster according to claim 1, further comprising:
a fluid output mechanism configured to output to an exterior the fluid which was boosted in pressure in the first pressure boosting chamber or the second pressure boosting chamber;
wherein the fluid output mechanism is configured to include a first outlet check valve configured to prevent back-flowing of the fluid into the first pressure boosting chamber, and a second outlet check valve configured to prevent back-flowing of the fluid into the second pressure boosting chamber.

5. The pressure booster according to claim 1, wherein the position detecting sensor comprises a first position detecting sensor configured to detect arrival of the first piston or the second piston at one end side of the first chamber or the second chamber, and a second position detecting sensor configured to detect arrival of the first piston or the second piston at another end side of the first chamber or the second chamber.

6. The pressure booster according to claim 1, wherein the position detecting sensor comprises a magnetic sensor configured to detect the position of the first piston or the second piston by detecting magnetism produced by a magnet attached to the first piston or the second piston.

7. The pressure booster according to claim 1, wherein:
a center body is interposed between the first chamber and the second chamber;
a first cover member is disposed at an end of the first drive chamber remote from the center body;
a second cover member is disposed at an end of the second drive chamber remote from the center body;
the first piston is displaced inside the first chamber without coming into contact with the center body and the first cover member; and
the second piston is displaced inside the second chamber without coming into contact with the center body and the second cover member.
